(19) United States
(12) Patent Application Publication
(10) Pub. No.: US 2011/0297754 A1
(43) Pub. Date: Dec. 8, 2011

(54) HOPPER-TYPE TEXTURE SPRAY APPARATUS AND HOPPER ASSEMBLY THEREFOR

(76) Inventor: Abel Valdez, Alvin, TX (US)

(21) Appl. No.: 13/153,841

(22) Filed: Jun. 6, 2011

Related U.S. Application Data
(60) Provisional application No. 61/352,121, filed on Jun. 7, 2010.

(51) Int. Cl. B05B 7/30; B05B 7/24

(52) U.S. Cl. 239/8; 239/345; 239/379

(57) ABSTRACT

A hopper assembly for a hopper-type texture spray gun applicator apparatus; the hopper assembly including a hopper reservoir housing such as an elongated tubular housing having a specific length to diameter (L/D) ratio. The hopper assembly is adapted for being removably connected to a spraying apparatus such as a spray gun which is coupled to a pressure source such as an air compressor for atomizing texture material contained in the hopper reservoir housing of the hopper assembly. The hopper assembly, the spray gun and the air pressure source may be used together to comprise a hopper-type texture spray gun applicator adapted for spraying texture material on work surfaces such as interior walls, floors and ceilings of a building.

### CROSS-REFERENCE TO RELATED APPLICATIONS

This Application claims the benefit of U.S. Provisional Application No. 61/352,121 filed Jun. 7, 2010.

### BACKGROUND OF THE INVENTION

1. Field of the Invention

The present invention relates to a hopper-type texture spray apparatus including a hopper assembly which is adapted to be removably attached to a spray apparatus; wherein the hopper-type texture spray apparatus is adapted for spraying various types of texture materials to be coated onto a surface.

2. Description of Background and Related Art

In the construction of a building, a texture material is often applied over work surfaces such as walls, ceilings, floors, and other surfaces amenable to be coated with said texture materials, in order to acquire aesthetic or acoustical effects. The texture material (also often referred to as “mud”), useful for texturing a surface, is typically heavy, thick and particulate.

There are various types and designs of devices/apparatuses known in the art for applying texture material to a surface, including for example, various apparatuses that are fashioned to convey texture materials through a system of differently arranged components in order to release the texture material with a stream of pressurized air utilized as a vehicle that transports and atomizes the texture material into particulates onto a work surface as a form of texture. Known apparatuses for applying texture material, or texture applicators, include for example: (1) large, complex and expensive texture applicators that are mounted on a vehicle bed, or towed behind a vehicle as a trailer such as described in U.S. Pat. No. 3,889,850; (2) portable texture applicator machines that have a hopper and motorized pump such as described in U.S. Pat. Nos. 5,443,211, 5,967,426, and 7,114,664; U.S. Patent Application Publication Nos. 2005/0254879 A1 and 2007/0286748 A1; and WO 2009/137639; (3) portable texture applicators having a pressurized tank containing a premixed texture material, wherein the texture material is forced through a hose connected to a spray device that is linked with an air line to an air compressor to atomize the texture material onto a work surface such as described in U.S. Pat. Nos. 3,945,571, 4,434,939, 6,383,560, 6,769,628; and U.S. Patent Application Publication Nos. 2002/0175222 A1 and 2004/0112982 A1; and (4) small texture applicators that operate much like a garden pesticide sprayer such as described in U.S. Pat. Nos. 4,411,387, 4,955,545, 5,069,390, 5,188,295; and U.S. Patent Application Publication No. 2004/0089742 A1; or like a spray can dispenser such as described in U.S. Pat. No. 5,188,263.

Another known texture applicator used in the building trades is related to a hopper-type spray device. The hopper-type spray device for spraying texture material is typically a hand-held applicator apparatus that includes a container or reservoir for containing texture material to be sprayed and for directing the texture material to a sprayer mechanism. The reservoir is commonly referred to as a “hopper”. Typically, the hopper is mounted on top of a spraying mechanism or spray device, commonly referred to as a “spray gun”. Several spray gun designs can be found in the prior art such as those described in U.S. Pat. Nos. 5,415,351, 5,979,797, 6,168,093, 6,450,422 and 7,617,995; U.S. Patent Application Publication No. 2009/0320752 A1; and WO 00/30757.

The common hopper design currently used in the construction industry is a hopper that expands generally pyramidically from bottom to top, i.e., a hopper viewed generally as an inverted (upside down) pyramid, wherein the top of the hopper having a feed opening for feeding texture material to the hopper; and the apex of the pyramid-like hopper (the bottom) has a discharge opening engaged in fluid communication with the spray gun such as illustrated in U.S. Pat. No. 4,863,104; U.S. Patent Application Publication Nos. 2002/0014563 A1, 2004/0129802 A1 and 2007/0108233 A1. The known hopper and spray gun, in combination, is commonly referred to as a “hopper-type spray gun applicator” or a “hopper gun”. There are a number of hopper gun designs in the prior art including for example the hopper guns described in U.S. Pat. Nos. 2,801,880, 2,887,274, 2,305,269, 2,964,302, 3,236,459; 3,945,571; 4,961,537, 5,727,736; 6,695,181, and 6,820,824; U.S. Patent Application Publication Nos. 2002/0014563 A1; 2004/0140373 A1, 2004/0256485 A1, 2007/0018016 A1, 2007/0108233 A1, 2007/0252019 A1, 2009/0014557 A1; WO 2009/137639 A1; German Patent No. 210449; and French Patent No. 2336186.

Typically, the texture material to be dispensed is contained in the hopper. The texture material contained in the hopper is gravity fed into a base of the spray gun; and the texture material is displaced from the base through a nozzle orifice at the front of the spray gun onto a surface area by a stream of air. The air stream typically originates from an air compressor that is linked to the spray gun. The air compressor places the hopper and spray gun under pressure and under the control of a trigger mechanism of the spray gun. The texture material, which is fed from the hopper under gravity to the spray gun, is entrained in a stream of pressurized air or other fluid, such as water, which is supplied to the spray gun from the air compressor.

One of the problems with the hopper guns of past designs is the hopper guns are of a size, shape and/or construction that limit the average person from producing a sprayed-on texture appearance on a work surface area located in a small, confined or “tight” work area of a building. In other words, known hopper guns are big, bulky, and heavy; and can be cumbersome to handle and operate. More often than not, spraying texture material in tight spaces with known hopper guns leads to a textured wall appearance that is considered structurally and aesthetically unacceptable.

For example, FIG. 1 illustrates a typical hopper gun similar to a number of designs of hopper guns currently available in the building and construction industry. The hopper gun shown in FIG. 1 includes a hopper, generally indicated by numeral 10, coupled to a conventional spray gun, generally indicated by numeral 20. Typically, the hopper 10 includes a hopper reservoir housing 11 with a feed opening 12 and a discharge opening (not shown) which is connected to the base 21 of the spray gun 20. The hopper 10 is coupled to the top of base 21 of the spray gun 20 with a coupling means, generally indicated by numeral 13, such as a mechanical clamp. Handle 22 of the spray gun 20 is coupled to a pressurized air coupling member 23 which, in turn, is linked to a pressurized air source 30 by an air hose 31 as shown in FIG. 1. The hopper 10 is designed to be mounted upright on the spray gun 20. The hopper 10 includes a built-in hand grip or handle 14 for lifting and holding the hopper 10 in a steady position by the operator with one hand while the operator holds the spray gun 20 in the other hand during operation of the prior art hopper gun shown in FIG. 1.

Before use, the hopper 10 is filled with a premixed texture compound or texture material to be applied to a work surface. In use, gravity feeds an amount of the premixed texture material contained in the hopper 10 into the base 21 containing a chamber (not shown) for receiving the texture material from the hopper reservoir housing 11 into the spray gun 20 via a hopper discharge opening (not shown) at the bottom of the hopper 10 and a feed texture material inlet orifice (not shown) in the base 21 of the spray gun 20; the two openings being in fluid flow communication with each other and held together with the coupling means 13. Pressurized air sprays the texture material from the base 21 out through a nozzle orifice 24 at the front of the spray gun 20, forming a spray pattern (not shown in FIG. 1).

The prior art hopper gun shown in FIG. 1 can be encumbering to a less skilled operator and can impede desired results as one hand of the operator actuates the trigger mechanism 25 of the spray gun 20, and the other hand braces the handle 14 on the hopper 10 necessary to support and right the filled hopper 10, leaving no hand free to adjust the material flow controls, that may be located on the spray gun 20, to regulate air pressure and/or to perform other work-related tasks. In addition, typically, the hopper reservoir housing 11 is made intentionally very big so as to hold a large quantity of texture material to minimize the filling and refilling of the hopper reservoir housing 11 with texture material during operation of the hopper gun. Therefore, the known hopper guns are difficult to use because the hopper guns are of a size that makes the hopper guns bulky and difficult to operate when spraying texture material in tight areas of a home or building such as closets and/or behind or around home appliances/devices which are semi-permanently anchored or positioned at a location and are not readily movable, such as furnaces, water heaters and the like. Prior known hopper guns typically create a mess when used because the texture material readily falls out of the hopper reservoir housing 11, or the texture material is inadvertently sprayed onto unintended surface areas because the hopper 10 is bulky and difficult to maneuver in tight spaces. Thus, the operator of the prior art hopper gun has to work double time—first to apply the texture material with the hopper gun and then to clean up messes remaining once spraying is complete.

### SUMMARY OF THE INVENTION

The present invention is directed to a hopper-type texture spray gun applicator, herein also referred to as a “texture sprayer”; wherein the texture sprayer includes a hopper assembly removably attached to a spray gun for spraying texture material wherein the texture sprayer is easy to use and cuts the time of use (i.e. spraying time) to a shorter time period than known hopper-type spray gun applicators. The present invention is also directed to a process for spraying texture material in which an operator is able to spray texture material using the texture sprayer of the present invention that is more efficient and economical.

One embodiment of the present invention includes a hopper assembly suitable for removably attaching to a spray gun of a pressure-operated, hand-held, texture sprayer of the present invention, wherein the texture sprayer is adapted for spraying various texture materials onto work surfaces such as walls, ceilings and floors. The hopper assembly of the present invention is designed to contain texture material and to feed the texture material to the spray gun of the texture sprayer.

In another embodiment of the present invention, the hopper assembly is adapted for receiving a pre-mixed texture material to be coated on a surface; and the hopper assembly is suitable for being removably mounted on top of a base of the spray gun. The hopper assembly relies on gravity to introduce the pre-mixed texture material, contained in the hopper assembly, into the spray gun such that the pre-mixed texture material can then be sprayed onto a surface area.

Yet another embodiment of the present invention includes a texture sprayer that employs a separate external source of pressurized air to spread the texture material onto a work surface with a stream of pressurized air.

Still another embodiment of the present invention includes an easier-to-use texture sprayer employing the hopper assembly of the present invention and a spray gun for spraying texture material. With the texture sprayer of the present invention, the texture material can be sprayed onto a work surface in a shorter time frame than previously known hopper guns. The hopper assembly of the present invention also makes the process of spraying texture material more efficient and economical because the present invention texture sprayer is practical, relatively small, and light weight; and can be easily used in areas of limited space.

One advantage of the present invention texture sprayer, over prior art hopper guns, includes the use of the present invention hopper assembly which is of a size that facilitates an operator to use the present invention texture sprayer with ease, i.e., using the texture sprayer of the present invention an operator can spray a texture material without much difficulty. The present invention texture sprayer is especially useful in areas where it is almost impossible or very difficult to use a big and bulky prior art hopper gun. For example, the present invention texture sprayer can be used in places that are complicated to work in such as in areas of limited space for example small closets; and such as in areas surrounding obstructions including for example air conditioners, water heaters, and cabinets. It is possible for an operator to handle the texture sprayer of the present invention with one hand and with less effort.

Another advantage of the present invention texture sprayer includes the use of the present invention hopper assembly which is of a design that saves texture material. For example, prior art hoppers waste a lot of the texture material when the texture material is applied or misapplied on a surface area. The present invention hopper assembly, on the other hand, is of a design that creates less waste of texture material when the texture material is applied on a surface area. In addition, the work finished with the present invention texture sprayer is of a better quality than similar prior art hopper guns.

Other advantages of the present invention texture sprayer include, for example: (1) the texture sprayer is easy to clean after its use and can be cleaned rather rapidly; (2) the hopper assembly of the texture sprayer can prevent the texture material contained in the hopper assembly from drying out; (3) the texture sprayer is relatively less expensive because it can be manufactured with less expensive materials and less materials of construction; (4) the texture sprayer saves the user money because it wastes less texture material; (5) the texture sprayer saves the user time, i.e., with the use of the present invention texture sprayer, it is easier to complete a project in less time than prior art hopper guns, thus saving the operator from the pressure or the stress of rushing against time, and the operator can take time to be more careful in spraying the texture material; (6) the work area, after spraying using the texture sprayer, is ready for use in less time; and (7) the work area, after spraying using the texture sprayer, is easy to clean.

### BRIEF DESCRIPTION OF THE DRAWINGS

The novel features of the present invention are set forth with particularity in the appended claims. The present invention, together with further objects and advantages thereof, may best be understood by reference to the following drawings. Embodiments of the present invention are shown in the several figures which are provided herein by way of example only. In the several figures which follow, like reference numerals identify like elements, and:

FIG. 1 shows a side elavation view of a spray gun, hopper, and pressure source according to the prior art.

FIG. 2 is an exploded perspective view of an embodiment of the hopper-type texture spray gun applicator of the present invention.

FIG. 2A is a front elevation view, partly broken away and partly in cross-section, of another embodiment of the texture sprayer of the present invention.

FIG. 2B is a front elevation view, partly in cross-section, of another embodiment of the texture sprayer of the present invention.

FIG. 3 is a side elevation view of another embodiment of the texture sprayer of the present invention.

FIG. 4 is a top cross-sectional view of the texture sprayer of the present invention taken along line 4-4 of FIG. 3.

FIG. 5 is a bottom plan view of the texture sprayer of the present invention taken along line 5-5 of FIG. 3.

FIG. 6 is a front plan view of the texture sprayer of the present invention shown in FIG. 3.

FIG. 7 is a rear plan view of the texture sprayer of the present invention shown in FIG. 3.

FIG. 8 is a side view, partly broken away and partly in cross-section of the hopper assembly of the texture sprayer shown in FIG. 3 and a bottom cover for the hopper assembly of the present invention.

FIG. 9 is a side portion view of the upper top portion of the hopper assembly of the texture sprayer shown in FIG. 3 and another embodiment of the top cover of the present invention, shown in an open arrangement.

FIG. 9A is a side portion view of the upper top portion of the hopper assembly of the texture sprayer shown in FIG. 3 and another embodiment of the top cover of the present invention removably attached to the hopper of present invention, shown in a closed arrangement.

FIG. 10 is a perspective side view of the present invention texture sprayer of FIG. 2 including a hopper assembly assembled and attached to a spray gun; and being operated by a user to provide a texture material spray pattern on a wall surface.

FIG. 11 is a top plan view of the present invention texture sprayer of FIG. 2 including a hopper assembly assembled and attached to a spray gun; being operated by a user to provide a texture material spray pattern on a wall surface; and being easily utilized in a “tight” space between the wall and a water heater.

### DETAILED DESCRIPTION OF THE PREFERRED EMBODIMENTS

Definitions

“Texture material”, “texture compound” or “mud” herein means a chalk compound; plaster; a coating material; or a mixture of a coating material and other compounds that are can be dispensed or sprayed on a surface. The texture material may also include for example a blend of texture compound(s) with water and/or paints.

“Hopper” or “hopper assembly” herein means an apparatus which comprises a container or reservoir for holding texture material to be dispensed therefrom.

“Hopper gun” or “spray gun” herein means a pistol-looking device with a barrel-looking portion, herein referred to as a “base”, a nozzle orifice, a handle, and an actuating trigger mechanism for actuating the dispensing of texture material via a pressurized fluid such that the texture material is propelled against a surface such as for example the surface of an interior wall of a building.

“Air compressor” herein means a device for delivering pressurized air to a spray gun.

“Tight”, “narrow”, or “small” with reference to a space is used herein to refer to a constricted, restricted, or encumbered area having surfaces to be coated with texture material; or an area with obstacles in the way of using a spray gun causing an obstruction to the spraying of a texture material directly on a surface; including for example, closet or bathroom interiors, under sinks, behind water heaters, spaces between the interior walls of a building and an appliance which is semi-permanently anchored or positioned at a location (i.e., not readily movable) such as an air conditioner, a water heater or other heavy-weighing appliance. For example, in accordance with some governmental regulations and building codes, generally, some appliances such as for example water heaters are required to be situated about 6 inches away from an interior wall of a building. This creates a tight or narrow space between the interior wall and the water heater, and typically, that amount of space is insufficient for an operator to accurately position a known big and bulky hopper gun between the water heater and the wall. Thus, an operator can not easily deliver a texture material spray pattern at the correct angle to adequately obtain an aesthetically pleasing and/or structurally sound coating on the wall. The water heater is an example of an obstruction to applying a spray pattern directly to a wall surface to be coated which may be behind the water heater.

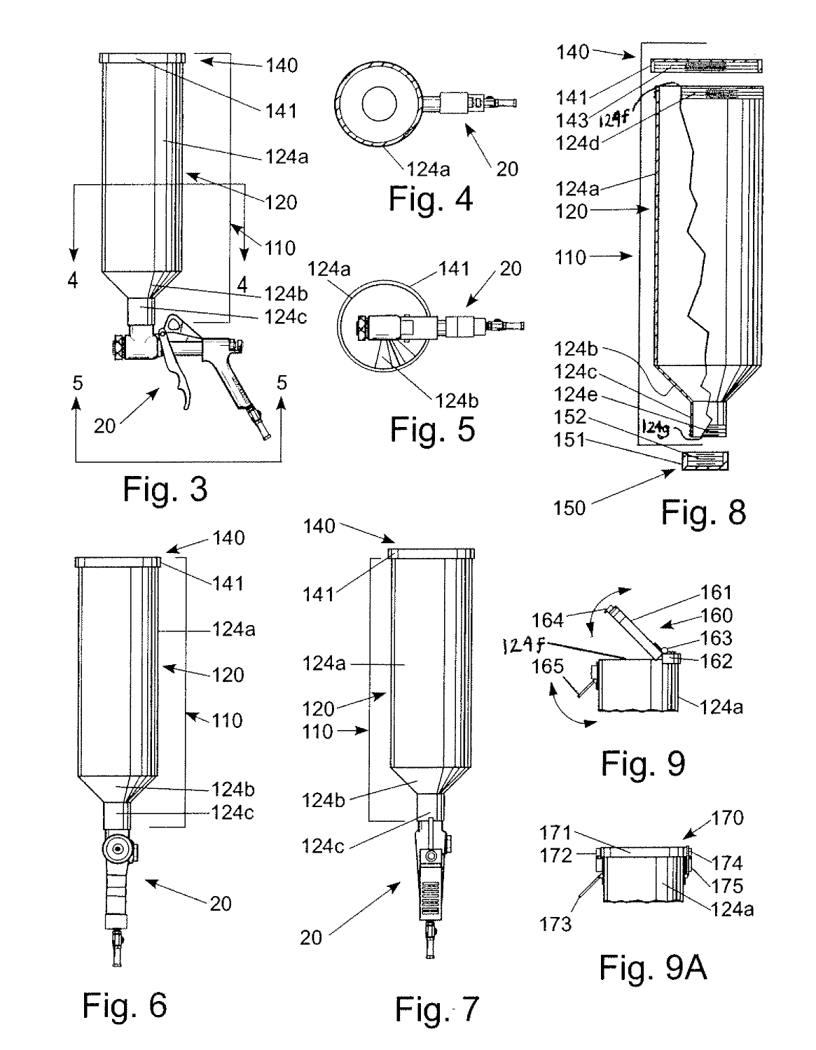

The present invention includes a hopper assembly and a spray gun; the combination of the hopper assembly and the spray gun may be referred to herein interchangeably as a “hopper-type texture spray gun applicator” or a “texture sprayer.” According to one embodiment of the present invention, shown in FIGS. 2-11, the texture sprayer, indicated generally by numeral 100, includes a hopper assembly, indicated generally by numeral 110, removably attached to a spray gun, indicated generally by numeral 20. Embodiments of the hopper assembly 110 of the present invention can be used with the spray gun 20 illustrated in FIG. 2, although the present invention is not so limited. Any texture spray gun known in the art which is compatible with and attachable to the hopper assembly 110 of the present invention may be used. The spray gun 20 may be selected from any conventional spray gun commercially available in the building and construction industry. For illustration purposes, the spray gun 20 of the texture sprayer 100 shown FIG. 2 is used as one example in the several embodiments of the present invention shown in FIGS. 2-11.

The hopper assembly 110 may include, for example, a hopper reservoir housing, generally indicated by numeral 120; an attachment means, generally indicated by numeral 130, adapted for removably attaching the hopper reservoir housing 120 to the spray gun 20; and optionally, a re-closable or sealable cover means, generally indicated by numeral 140, adapted for removably attaching to the hopper reservoir housing 120.

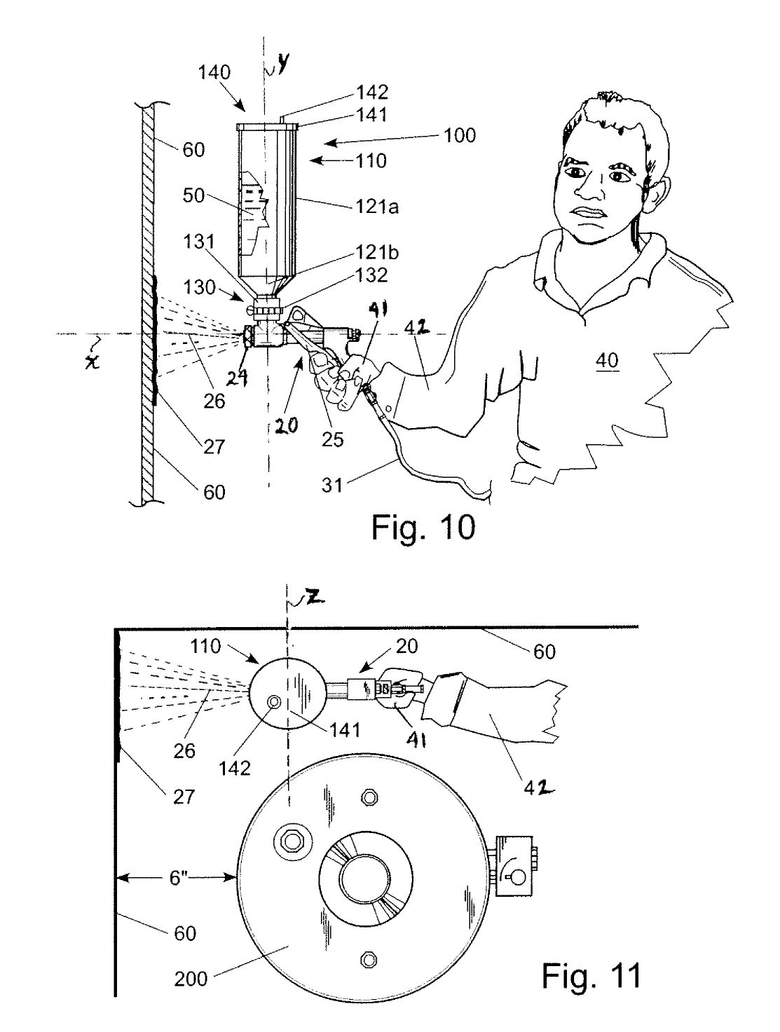

The hopper assembly 110 may be removably attached to a base 21 of the spray gun 20; said base 21 containing an inlet means (see for example texture receiving opening 21a shown in FIGS. 2, 2A and 2B) for receiving texture material which discharges from the hopper reservoir housing 120 (see for example texture discharge opening 121e shown in FIG. 2). The texture material passes through the inlet means of base 121 into a receiving chamber (not shown) in base 21. The hopper reservoir housing 120 of the hopper assembly 110 may contain a supply of texture material (shown as numeral 50 in FIG. 10) for use in spraying a surface coating on a surface such as a wall (shown as numeral 60 in FIGS. 10 and 11).

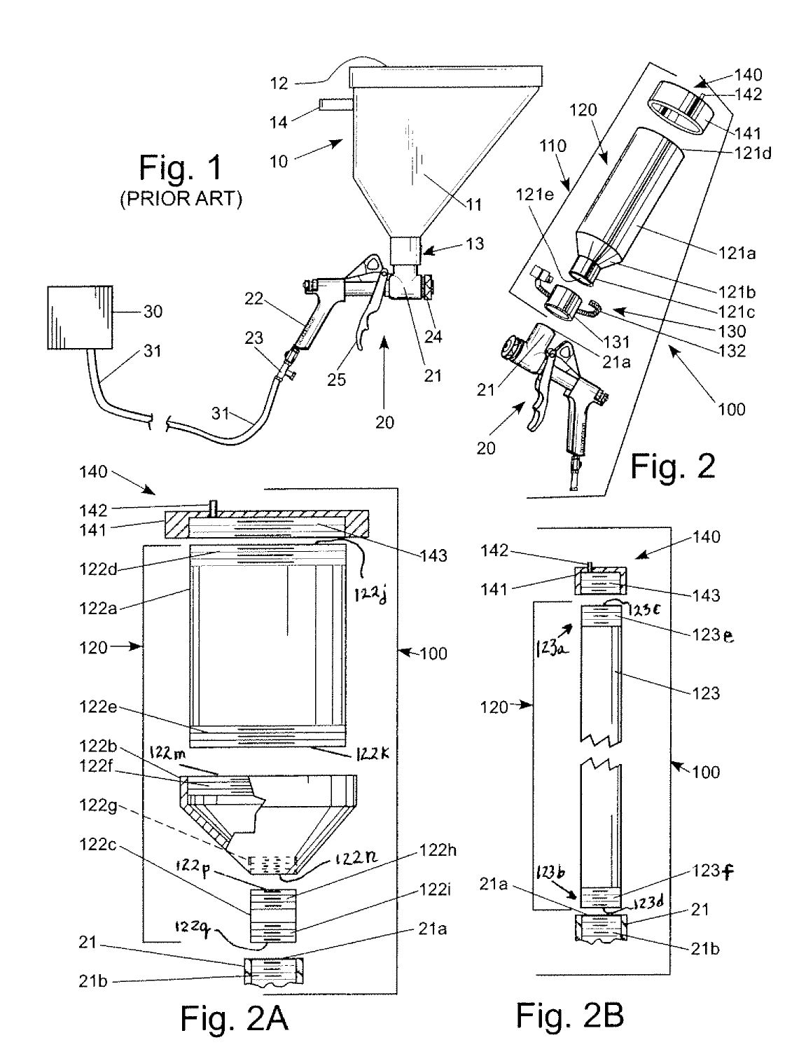

The hopper assembly 110 of the texture sprayer 100 of the present invention is mounted on top of the base 21 of the spray gun 20; and the texture sprayer 100 relies on gravity to introduce a premixed texture material that is contained in the hopper assembly 110 to flow into the spray gun 20 through the texture material receiving opening 21a of the base 21. To atomize the texture material onto a work surface, the texture sprayer 100 of the present invention may use a fluid stream for example an air stream from a conventional air compressor 30 similar to the compressor shown in FIG. 1. The spray gun 20 may be linked to the air compressor 30 with an air line 31 that is removably attached to the spray gun 20 via handle 22 and air line coupling means 23.

Again with reference to FIGS. 2-11, the hopper assembly 110 includes (a) the hopper reservoir housing 120, herein referred to as the “hopper 120” having a texture material feed inlet means (for example, the feed opening 121d shown in FIG. 2) and a texture material discharge outlet means (for example, the discharge opening 121e shown in FIG. 2); (b) the attachment means 130 for removably attaching the hopper assembly 110 to the spray gun 20; and (c) the optional sealable cover means 140 which may include a cover or lid 141 and an air intake orifice 142, wherein the air intake orifice 142 itself may optionally have a sealable cover means (now shown), or may be open to the atmosphere as shown in FIGS. 2, 2A, 2B, 10 and 11.

FIGS. 2-11 show various embodiments of the hopper 120 of the present invention. For example, one embodiment of the hopper 120, shown in FIG. 2, comprises a one-piece member 120 made up of three hopper sections, 121a, 121b and 121c integral with each other forming the one-piece hopper 120; the hopper 120 of FIG. 2 having a texture material feed opening 121d and a texture material discharge opening 121e. The three hopper sections 121a, 121b, and 121c of the hopper 120 are of a shape and diameter to allow a sufficient flow of texture material into the base 21 of the spray gun 20.

In the embodiment shown in FIG. 2, the hopper 120 includes for example an upper cylindrical or elongated tubular hopper section 121a integral with a funnel-shaped, frusto-conical, or conical middle hopper section 121b, which in turn, is integral with a lower cylindrical or annular ring hopper section 121c. The conical middle hopper section 121b of the hopper 120 is tapered for maximum texture material flow through the middle hopper section 121b and the annular ring hopper section 121c and into the spray gun 20. The upper elongated tubular hopper section 121a has the texture material feed opening 121d which can be of the same diameter or of a different diameter from the upper elongated tubular hopper section 121a. The texture material feed opening 121d is preferably of a size or diameter sufficient to allow texture material to be supplied to the hopper 120.

Also, in the embodiment shown in FIG. 2, the hopper section 121a may be of a shape, length and diameter to allow a sufficient flow of texture material to flow from the hopper 120 into the base 21 of the spray gun 20. For example, the cross-sectional shape of the hopper section 121a may be in the shape of a circular wall member of a predetermined diameter, when viewed in a cross-sectional view along the horizontal axis of the hopper section 121a. However, the present invention is not to be limited to a hopper section 121a having a circular cross-section shape when viewed in cross-section. The shape of the hopper section 121a, when viewed in cross-section along its horizontal axis, may be for example, squared, rectangular, triangular, hexagonal; or other polygon cross-sectional shape. In one embodiment, the shape of the hopper section 121a is circular in shape when viewed in cross-section, such as for example the upper elongated tubular hopper section 124a shown in FIG. 4.

The length of the hopper section 121a of the hopper 120, for example, may be generally from about 1 inch to about 18 inches in one embodiment; from about 1 inch to about 15 inches in another embodiment; from about 1 inch to about 12 inches in another embodiment; from about 1 inch to about 10 inches in another embodiment; from about 1 inch to about 8 inches in another embodiment; and from about 1 inch to about 6 inches in another embodiment.

The diameter of the hopper section 121a, for example, may be generally from about 0.5 inch to about 8 inches in one embodiment; from about 1 inch to about 6 inches in another embodiment; and from about 2 inch to about 4 inches in another embodiment.

The dimensions of a preferred hopper section 121a, in terms of length to diameter (L/D) ratio, generally may be from about 1 L/D ratio to about 36 L/D ratio in one embodiment; from about 1 L/D ratio to about 30 L/D ratio in another embodiment; from about 1 to about 20 L/D ratio in another embodiment; from about 1.5 L/D ratio to about 10 L/D ratio in another embodiment; and from about 2 to 6 L/D ratio in yet another embodiment. In yet another embodiment, the L/D ratio of the hopper section 121a is generally greater than or equal to (≧) 1; ≧2 in another embodiment; ≧3 in another embodiment; ≧4 in another embodiment; ≧5 in another embodiment; ≧6 in another embodiment; and ≧7 in another embodiment.

As an illustration of one embodiment of the present invention, for example, when the diameter of the hopper section 121a is 2 inches, the L/D ratio may be 5 in one embodiment; the L/D ratio may be 4 in another embodiment; and the L/D ratio may be 3 in yet another embodiment. As an illustration of another embodiment of the present invention, for example, when the diameter of the hopper section 121a is 4 inches, the L/D ratio may be 4 in one embodiment; the L/D ratio may be 3 in another embodiment, and the L/D ratio may be 2 in yet another embodiment.

The conical middle hopper section 121b of the hopper 120 is conical or funnel in shape to transition the diameter of the upper elongated tubular hopper section 121a to the diameter of the annular ring hopper section 121c. The hopper section 121b has a top feed opening integral with the lower portion opening (opposite the feed opening 121d) of the upper elongated tubular hopper section 121a; and the diameter of the top feed opening of the funnel-shaped hopper section 121b is adapted to integrally fit the diameter of the upper elongated tubular section 121a. The hopper section 121b has a bottom discharge opening integral with the upper portion opening (opposite the discharge opening 121e) of the annular ring hopper section 121c; and the diameter of the bottom discharge opening of the funnel-shaped hopper section 121b is adapted to integrally fit the diameter of the lower annular ring hopper section 121c.

In general, the length of the annular ring hopper section 121c is of a length sufficient to transition the funnel shaped hopper section 121b to the feed opening 21a of the base 21 of the spray gun 20; and the length of the hopper section 121c is adapted to allow the flow of texture material into the spray gun 20. For example, the hopper section 121c is generally from about 0.5 inch to about 4 inches in length in one embodiment; and from about 1 inch to about 2 inches in length in another embodiment. In general, the diameter of the hopper section 121c is adapted to engage the diameter of the feed opening 21a of the base 21 of the spray gun 20; and the diameter of the hopper section 121c is adapted to allow the flow of texture material from the hopper 120 into the spray gun 20. For example, the diameter of the hopper section 121c is generally from about 0.5 inch to about 4 inches in diameter in one embodiment; and from about 1 inch to about 2 inches in diameter in another embodiment.

FIG. 2A shows another embodiment of the hopper 120 made up of three individual hopper reservoir housing section members 122a, 122b, and 122c, separate and apart from each other but which can be removably connected to each other, for example by male threadable portions and female threadable portions contained in the various hopper section members 122a, 122b, and 122c, so as to form a one-piece hopper 120 when connected together as described below.

The hopper 120 shown in FIG. 2A includes the three separate, but connectable, hopper section members 122a, 122b, and 122c, respectively. The three section members may be removably connected to each other by any means such as threaded means as shown in FIG. 2A. For example, hopper section member 122a having a feed opening 122j and a discharge opening 122k includes external male threaded portions 122d and 122e. The hopper section member 122b having a feed opening 122m and a discharge opening 122n includes internal female threaded portions 122f and 122g. The hopper section member 122c having a feed opening 122p and a discharge opening 122q includes external male threaded portions 122h and 112i, respectively. Hopper section member 122a removably connects to hopper section member 122b via the male threaded portion 122e of hopper section member 122a with the female threaded portion 122f of the hopper section member 122b. Hopper section member 122b, in turn, removably connects to hopper section member 122c via the female threaded portion 122g of hopper section member 122b with the male threaded male portion 122h of hopper section member 122c. When the hopper section members 122a, 122b and 122c of the hopper 120 are connected to each other, the male threaded portion 122i of section 122c can be connected to the female threaded portion 21b of the spray gun 20.

Although not illustrated, a two-piece hopper reservoir housing may be used as another embodiment of the hopper 120 of the present invention comprising, for example, (i) a combination of the hopper reservoir housing section members 122a and 122b of FIG. 2A integral with each other and forming the first piece of the two-piece hopper reservoir housing; and (ii) the hopper reservoir housing section member 122c of FIG. 2A forming the second piece of the two-piece hopper reservoir housing; wherein the first piece is removably attached to the second piece, and upon connecting together, form the one-piece hopper 120.

In another embodiment of the hopper 120, although not illustrated, another two-piece hopper reservoir housing may be used as the hopper 120 of the present invention. In this case, the two-piece hopper reservoir housing may comprise (i) the hopper reservoir housing section member 122a of FIG. 2A forming the first piece of the two-piece hopper reservoir housing; and (ii) a combination of hopper reservoir housing section members 122b and 122c of FIG. 2A integral with each other and forming the second piece of the two-piece hopper reservoir housing; wherein the first piece is removably attached to the second piece, and upon connecting together form the one-piece hopper 120.

In yet another embodiment of the hopper 120, shown in FIG. 2B, there is illustrated a one-piece elongated tubular member 123 which may be used as the hopper 120 of the present invention. The elongated tubular member 123 comprises one same diameter dimension continuous throughout the longitudinal length of the elongated tubular member 123. For example, the one-piece elongated tubular member 123 embodiment shown as hopper 120 in FIG. 2B comprises the same diameter from an upper distal end portion, generally indicated by numeral 123a, of the elongated tubular member 123 to a lower proximal end portion, generally indicated by numeral 123b, of the elongated tubular member 123.

Again with reference to FIG. 2B, the one-piece elongated tubular member 123 includes a texture material feed opening 123c at the upper distal end portion 123a and a texture material discharge opening 123d at the lower proximal end portion 123b. In addition, the one-piece elongated tubular member 123 includes an external male threaded portion 123e at the upper distal end portion 123a; and an external male threaded portion 123f at the lower proximal end portion 123b. The external male threaded portion 123e may be removably connected to the internal female threaded portion 143 of the lid cover 141; and the external male threaded portion 123f may be removably connected to the internal female threaded portion 21b of the spray gun 20.

In other embodiments, the overall shape of the hopper 120 when viewed in a perspective side view may be of any shape adapted to allow the gravitational flow of texture material from the hopper 120 into the base 21 of the spray gun 20 without any interior areas of repose, such as a ledge, where texture material can settle and accumulate, which in turn may eventually lead to constricting the feed opening of the base 21 of the spray gun 20 and thus, restricting the flow of texture material. For example, the shape of the hopper 120 when viewed in a perspective side view can be cylindrical, hour-glass shaped, conical, oval, egg-shaped, or tapered.

The hopper assembly 110 of the present invention may be made of any material known in the art for such types of devices. For example, the hopper assembly 110 may be constructed of light weight materials such as aluminum, plastic, fiberglass, and mixtures thereof. In one embodiment, the construction of the hopper assembly 110 is such that the hopper assembly 110 may weigh less than about 5 pounds; and in another embodiment less than about 2 pounds.

Before operating the texture sprayer 100 of the present invention, the hopper assembly 110 must first be securely connected to the spray gun 20. The coupling of the hopper assembly 110 to the spray gun 20 can be done with any type of detachable or removable fastening or attachment means 130 such as for example a threadable, snappable, latchable, or other securable or fastening means for removably attaching and detaching the hopper assembly 110 from the spray gun 20. For example, the removable attachment means 130 may include a tubular adaptor member 131 and a clamping means such as a universal clamp 132 as shown in FIG. 2 and FIG. 10.

Other embodiments of the attachment means 130 can include, for example, a threaded male and a threaded female connecting means integral with the hopper 120. For example, in the embodiment shown in FIG. 2A, the hopper section member 122c of the hopper 120 may also function as the attachment means 130 since the hopper section member 122c includes threaded male portions 122h and 122i; and the male threaded portion 122h of the hopper section member 122c can be threadably connected to the female threaded portion 122g of hopper section member 122b; and the male threaded portion 122i of the hopper section member 122c can be threadably connected to the female threaded portion 21b of the spray gun 20. Other embodiments of the attachment means 130 may include for example clamping means, latching means, and other attachment means well known in the art.

In one embodiment of the present invention, the hopper feed opening 121d at the upper distal end of hopper section 121a of the hopper 120 can be left open to the atmosphere, or in an alternative embodiment, the hopper feed opening 121d at the upper distal end of the hopper section 121a may be sealed with the optional removable or sealable cover means 140, such as lid 141. The sealable cover means 140 such as lid 141 of the present invention may optionally include one or more small perforations or orifices, such as a tubular air intake orifice member 142, for allowing air to pass into the hopper 120 and replace the flowing texture material as the texture material exits the hopper 120 by gravity flow.

With reference to FIGS. 2, 2A, 2B and 8 again, there is shown the sealable cover means 140 which includes the lid 141, the optional air intake orifice 142, and the optional internal female threaded portion 143. In the embodiment shown in FIG. 2, the lid 141 does not contain an internal threaded portion; and thus, the lid 141 may be press fitted or force-fitted to the feed opening 121d of the hopper 120. In the other embodiments of the optional re-closeable lid 141 useful in the present invention shown in FIGS. 2A, 2B, and 8, the lid 141 does contain, for example, internal female threaded portion 143 adapted to be threadably attached to the hopper 120.

In FIG. 2A, for example, the internal female threaded portion 143 of the lid 141 can be removably connected to the external male threaded portion 122d of the hopper section member 122a to seal the feed opening 122j of the hopper section member 122a of hopper 120.

In FIG. 2B, for example, the female threaded portion 143 of the lid 141 can be removably connected to the external male threaded portion 123e of the one-piece elongated tubular hopper member 123 to seal the feed opening 123c of the hopper member 123.

In FIG. 8, for example, the female threaded portion 143 of the lid 141 can be removably connected to the external male threaded portion 124d of the hopper reservoir housing section 124a to seal the feed opening 124f of the hopper section 124a of hopper 120.

As one example of operating the texture sprayer 100, the hopper assembly 110 of the present invention shown in FIG. 2 may be used. The hopper 120 of FIG. 2 has the texture material hopper feed opening 121d, located at the upper distal end of the hopper 120, adapted to provide a means for filling the hopper 120 by pouring a predetermined volume of texture material into the hopper 120; and adapted to refill the hopper 120 when the hopper 120 is empty. The hopper 120 also has the texture material discharge opening 121e, located at the lower proximal end of the hopper 120, adapted to connect, in fluid communication, the hopper assembly 110 to the spray gun 20. After attaching the hopper assembly 110 to the spray gun 20, the hopper 120 is filled with texture material through the hopper feed opening 121d at the upper distal end of the hopper 120. When all of the above connections are securely made, the hopper assembly 110 of the present invention is complete and ready for operation.

FIG. 9 shows another embodiment of the optional re-closeable cover or lid of the present invention in the form of a hinged lid, generally indicated by numeral 160, including a movable lid portion 161 and a fixed lid portion 162 fastened to the hopper member 124a. The movable lid portion 161, in this instance can pivot on one or more hinge members 163, to swing the lid portion 161 in an upwardly or downwardly direction, in an opened or closed position, respectively. The fixed lid portion 162 can be fastened to the hopper member 124a by any attachment means such as welding or bolting. The movable lid portion 161 can be fastened to the hopper member 124a with one or more clip means such as latching members 164, 165 for removably attaching the movable lid portion 161 to the hopper member 124a of the hopper 120 for sealing the lid in a closed position; or for opening the lid in an open position as shown in FIG. 9.

Yet another embodiment of the optional re-closeable cover or lid of the present invention, in the form of a removable lid, generally indicated by numeral 170, is shown in FIG. 9A. In this instance, the lid 170 is removably fastened to the hopper member 124a of the hopper 120 with two or more clips. For example, the optional re-closeable lid 170 may include a lid 171 with two or more clip means such as latching members 172, 173 and 174,175 for removably attaching the lid 171 to the hopper member 124a of hopper 120 as shown in FIG. 9A.

In another embodiment of the present invention, the discharge opening of the hopper reservoir housing 120 hopper located at the proximal discharge end of the hopper 120, may be sealed with an optional removable bottom cover means for sealing the discharge opening of the hopper 120, for example, when the hopper 120 is not in use and not connected to the spray gun 20. For example, as shown in FIG. 8, the hopper 120 can include an optional removably attachable bottom cover, generally indicated by numeral 150, including a bottom cover 151 having internal female threaded portion 152. The bottom cover 151 and the top lid 141, without an air intake orifice 142, are used in combination to enclose any unused texture material remaining in the hopper 120 in an air tight manner to prevent the texture material in the hopper 120 from drying out. For example, the reclosable bottom cover 151 and top lid 141 can be used for temporarily storing any unused texture material remaining in the reservoir of the hopper 120 for later use. In the embodiment shown in FIG. 8, the top lid 141 and bottom cover 151 can be used to seal the hopper 120 by itself without cleaning at the end of a work day. The texture material in the sealed hopper 120 remains moist, and thus, the texture material can be used the next work day.

Although not shown, the hopper 120 of the present invention may include various optional structural features without taking away from the overall design and function of the hopper. For example, in one embodiment the hopper of the present invention may incorporate an optional handle integral with the hopper at the upper end of the hopper, such that the handle is adapted for gripping the hopper with a free hand during operation of the hopper or for carrying the hopper to a work site. During operation of the texture sprayer of the present invention, the handle incorporated at the upper end of the hopper may provide assistance to the operator for positioning the spray system in an upright position for stability enabling the texture sprayer to become fully and readily operational.

In another embodiment, the hopper 120 may include a means for determining the level of texture material in the hopper. For example, the hopper of the present invention may optionally include a transparent window for viewing the texture material in the hopper at one or more levels of the hopper to allow the user to known the amount of texture material remaining in the hopper.

In another embodiment, an optional indicator means such as a visible indicator light can be added to the hopper 120 of the present invention to indicate for example one or more levels of texture material in the hopper; or to determine when the hopper is empty of texture material.

The spray gun 20 useful in the present invention may be selected from any of the well known spray guns available in the market suitable for removably attaching to the hopper assembly 110 and adapted for spraying a texture material. The spray gun 20 of the present invention comprises a hand-held, pressure-operated, spray gun adapted for spraying a texture material onto surfaces such as ceilings, walls, and floors for texturizing the surfaces. Preferably, the spray gun is pneumatic and is used in the present invention for spraying bulk texture material from the hopper 120. The spray gun 20 is capable of atomizing the texture material onto a work surface.

The spray gun 20 useful in the present invention for spraying texture materials is adapted for connecting to a container, reservoir, or hopper that fits or connects to, for example, the base 21 of the spray gun 20; wherein the base 21 is adapted for receiving and connecting the hopper 120 of the present invention to the spray gun 20. The spray gun 20 also includes a feed opening means 21a for receiving the texture material from the hopper 120 such that the texture material flows from the hopper 120 to the spray gun 20; a nozzle orifice 24 adapted for spraying the texture material from the spray gun 20; a handle 22; and a coupling means 23 adapted for receiving and connecting to a source of air such as a compressor means 30 adapted for atomizing the texture material with an air stream flowing through the spray gun nozzle orifice 24 to propel and eject the texture material from the spray gun 20 in a spray pattern 26 onto a surface such as a wall 60 to form a coating layer 27 on the wall 60.

The pressurized air from the nozzle orifice 24 of the spray gun 20 atomizes the texture material onto a work surface. To atomize the texture material on a work surface, the spray gun 20 is linked to an air compressor 30 with an air line 31 that feeds a stream of pressurized air to the spray gun 20 and mixes with the texture material to develop a spray of texture material such that when the texture material is deposited onto a surface, such as wall 60, it results in a textured coating 27 on the surface of wall 60.

The process and apparatus of the present invention provides for the pressurized application of texture material to a work surface using the texture sprayer 100 of the present invention. Various types of texture materials can be sprayed onto a surface, including any common texture material known in the market for applying to architectural surfaces of the interior or exterior of a building including bulk, heavy, viscous texture materials. The texture materials suitable for spraying using the texture sprayer 100 of the present invention may include for example heavy or viscous materials; liquidus coating materials; slurries; and other sprayable materials amenable to provide a coating on a surface including for example drywall mud texture material, stucco material, chalk compound and plaster. Other texture materials useful for spraying on a surface which has previously been coated with a texture material, such as for example, textured ceilings and/or walls.

One common spray texture material includes a compound for forming indoor ceiling or wall patterns such as “popcorn” texture, although the present invention is not so limited. Other spray texture materials may include for example, exterior stucco, and smooth texture interior drywall mud for spraying level five flat surfaces, and the like.

As aforementioned, the texture sprayer 100 for applying texture material onto a work surface comprises (a) the hopper assembly 110 having a hopper 120 adapted to accept, contain, and be drained of a texture material; and (b) the spray gun 20; wherein the hopper assembly 110 is removably coupled to the spray gun 20 via attachment means 130; and wherein the spray gun 20 is removably coupled to a means to distribute supplied air pressure to the spray gun 20 such as an air compressor 30 together with air line 31 coupled to the spray gun 20. When all of the above-described connections are securely made, and the hopper 120 is filled with texture material; the texture sprayer 100 of the present invention is ready for operation. An operator 40 may begin the spraying operation by turning on the air pressure source such as the air compressor 30 to begin the flow of air from the air compressor to the texture sprayer 100. The texture sprayer 100 is advantageously portable; and the operator 40, using the texture sprayer 100, can advantageously work alone in a manner considered safe, efficient, and cost effective.

In one embodiment, the operation of the texture sprayer 100 of the present invention may be described with reference to FIGS. 10 and 11. With reference to FIGS. 10 and 11, the operator 40 is shown spraying a texture material 50 onto a wall 60 (for example as shown in FIG. 10) with the hopper-type texture spray applicator 100 held in the operator’ right hand 41 of the operator's right arm 42. For the texture material 50 contained in the hopper 120 to reach a work surface such as the wall 60 in texture form, the texture material 50 must be broken down into particulates for example by introducing the texture material into a stream of pressurized air that also acts as the vehicle that scatters the texture material onto a work surface. This happens when the operator 40 releases both texture material and air, together, from the spray gun nozzle orifice 24 by depressing or squeezing the trigger 25 of the spray gun 20, i.e., pulling back the trigger 25 toward the handle 22 of the spray gun (with the operator's fingers of the right hand 41) as shown in FIG. 10 to actuate the flow of air.

Air pressure for both the hopper 120 and the spray gun 20 is generated from the air compressor 30 (for example the compressor 30 shown in FIG. 1). The routing of air pressure supplied by the air compressor 30 to the spray gun 20 is carried out by a shared air hose or air line 31 wherein the spray gun air line 31 descends from the spray gun 20 to the air compressor 30. In one embodiment, the length of the air line hose 31 may only be as long as required by an operator's reach. The air line 31 coupled to the air gun 20 via a coupling member 23 allows constant air pressure to be maintained to the spray gun 20. If desired, in one embodiment, air pressure to the spray gun 20 can be monitored using an attached air pressure regulator (not shown). In addition, in another embodiment, the air coupling member 23 includes a selectively actuated valve (not shown) which can be used to control the supply of air to the spray gun 20. The spray gun 20 with air stream directs a spray pattern 26 to a surface area such as wall 60.

The texture sprayer 100 shown in FIG. 10 may be the same texture sprayer shown in FIG. 2 in an assembled fashion. In this embodiment, for example, the hopper 120 is held by the spray gun 20 in an upright position for filling and use. The hopper 120 accepts the texture material through the feed opening 121d (see FIG. 2) located at the top distal end of the upper elongated tubular section 121a. Once the hopper 120 is filled with texture material, the texture material is ready to be sprayed against a wall or work surface. By gravitational force, the texture material is forced down from the discharge opening 121e and into the texture material feed inlet or opening 21a (for example as shown in FIGS. 2A and 2B) of the base 21 of the spray gun 20. An air source such as the air compressor 30 is shown with the primary air line 31 linking the air compressor 30 to the air inlet coupling member 23 of the spray gun 20. Pressurized air is introduced into the spray gun 20 which forces the texture material out of the spray gun 20 through the spray orifice in nozzle 24 of the spray gun 20. The spray gun 20 is integrated with the hopper 120. The hopper 120 is coupled to the spray gun 20 via the lower proximal end of the hopper 120 by the discharge orifice 121e of the hopper 120 and the feed opening orifice 21a of the spray gun 20, allowing the texture material to continue into the spray gun 20. The texture material 50 is forced out of the spray gun 20 through orifices of the spray gun nozzle 24 of the spray gun 20 forming a spray pattern 26. In one embodiment, the nozzle orifice 24 may comprise one or more orifices of varying sizes mounted on a wheel (not shown) to offer the user a selection of different orifices to provide different spray patterns. The atomized texture material particulate in the spray pattern 26 deposits on the wall surface 60 producing a layer of textured coating 27.

With reference to FIGS. 10 and 11 again, the operator 40 may spray the texture material 50 on a wall 60 with the texture sprayer 100 at various angles depending on the constraints facing the operator 40. For example, the operator 40 can spray texture material while the hopper 120 is at any angle sufficient to allow texture material 50 to flow, by gravitational force, to the spray gun 20. Generally, there are several angles of rotation in which the texture sprayer 100 can be operated starting from a point wherein the hopper assembly 110 is positioned in an upright well-balanced vertical position which is mounted vertically on the spray gun 20 (as shown in FIG. 10) such that the vertical center axis, y, of the hopper 120 is parallel to the vertical plane of the wall 60; and such that the horizontal center axis, x, of the orifice of the nozzle 24 at the front end of the spray gun 20 is facing and aimed at the wall 60 directly perpendicular to the vertical plane of the wall 60.

For example, (1) the rotation of the spray gun 20 may pivot or rotate on the vertical center axis y of the hopper 120 from left to right or right to left spraying texture material across the surface of the vertical plane of the wall 60; in this case the hopper, relative to its y axis, remains in the same position, and only the spray gun 20 with the nozzle orifice 24 moves from a position directly perpendicular to the vertical plane of the wall left to right or right to left beyond a certain angle of degrees until the spray stream from the spray gun no longer contacts the wall; (2) the rotation of the spray gun 20 may pivot or rotate on the horizontal center axis x of the orifice of the nozzle orifice 24 at the front end of the spray gun 20, said axis x being perpendicular to the vertical plane of the wall 60; in this instance, the spray gun 20 with the nozzle orifice 24 facing the vertical plane of the wall, remains perpendicular to the vertical plane of the wall and the hopper 120 rotates from an upright position from left to right or right to left on a vertical plane of rotation parallel to the vertical plane of the wall 60 beyond a certain angle of degrees until the texture material contained in the hopper 120 can no longer flow from the hopper 120 to the spray gun 20; (3) the rotation of the spray gun together with the hopper may pivot or rotate, in an upward or downward direction, on a horizontal axis z located through the base 21 of the spray gun 20 (as shown more clearly in FIG. 11); in this instance, the axis z is parallel to the vertical plane of the wall 60, wherein the plane of rotation of the spray gun and hopper together is perpendicular to the vertical plane of the wall 60 such that the spray gun 20 and the hopper 120 together rotate facing the vertical plane of the wall 60 in a downward or upward direction moving in the perpendicular plane to the vertical plane of the wall; and wherein the hopper 120 moves on a plane of rotation perpendicular to the plane of the wall 60 beyond a certain angle of degrees until the texture material contained in the hopper 120 can no longer flow from the hopper 120 to the spray gun 20, or beyond a certain angle of degrees until the spray stream from the spray gun 20 no longer contacts the wall 60; or (4) a combination of any of the above rotations (1)-(3). In general, the angle of spray in any of the above rotations (1)-(4) can be any angle in the range of from about 10 degrees vertically (up or down), or horizontally (side to side) to about 170 degrees in one embodiment; from about 25 degrees to about 145 degrees in another embodiment; and from about 45 degrees to about 135 degrees in yet another embodiment.

The distance between the nozzle orifice 24 of the spray gun 20 to the surface 60 to be coated can be any distance sufficient to provide the desired thickness of the coating on the surface. This distance will depend on several factors including for example the angle of the spray; whether or not the texture sprayer 100 fits in the tight spaces to allow for a proper angle to spray the surface; and the viscosity and consistency of the texture material. For example, if the texture material is a heavy mixture, the distance from the surface to the nozzle orifice of the spray gun is generally from about 2 inches to about 10 inches in one embodiment; and from about 2 inches to about 4 inches in another embodiment. In another example, if the texture material is a light mixture, the distance from the surface to the nozzle orifice of the spray gun is generally from about 2 inches to about 10 inches in one embodiment; and from about 6 inches to about 8 inches in another embodiment. In some instances, government regulations may set the distance requirement between a surface and the location of an appliance such as for example a water heater or a furnace. For example, as shown in FIG. 11, the U.S. government regulation dictate that the required distance between the wall 60 and a water heater 200 is typically set for at least six inches spaced away from the wall 60. The texture sprayer 100 of the present invention advantageously can operate between these types of regulated distances as shown in FIG. 11.

The time it takes to complete a spraying operation using the texture sprayer 100 of the present invention will depend on various factors including for example the size of the area to be coated, the number of restricted tight places such as closets and under sinks, and thickness of the coating layer required. In general, the present invention texture sprayer 100 advantageously provides a more effective coating of texture material on a surface; and thus, more small spaces may be coated with texture material in less time and with less texture material as compared to prior art devices.

For example, to apply texture material to the interior walls of a standard size closet having typical squared area dimensions of for example, 5 feet by 3 feet, using the prior art apparatus shown in FIG. 1, three closets can be completely textured with texture material in about eight hours using three operators 40. In comparison, using the present invention texture sprayer 100, such as shown in FIG. 2, closets of the same size (e.g. 5 feet by 3 feet), can be completely textured with texture material in about three hours by a single operator 40.

In addition, as a general illustration of the present invention, the present invention texture sprayer 100 advantageously provides less texture material to cover the same coating area with a layer of texture material of, for example, from about a quarter inch thick to about one half inch thick. For example, typically for small tight spaces, a commercially available small texture applicator of the prior art, that operates much like a garden pesticide can sprayer similar to the spray can described in U.S. Pat. No. 5,188,263, is commonly used by the construction industry. The prior art spray cans of texture material can be commercially obtained in boxes or cases, wherein one case contains 12-15 ounce spray cans. With the prior art spray cans, it takes about two cases of 12 spray cans each to completely cover one standard size closet (e.g. 5 feet by 3 feet) with texture material; or a supply of six cases of 12 spray cans each to completely cover three of the above standard size closets.

However, with the texture sprayer 100 of the present invention, for the same area of the three aforementioned standard size closets, less texture material will be required and at a lower cost. For example, using the present invention texture sprayer 100, such as shown in FIG. 2, the three aforementioned standard size closets of the same size (e.g. 5 feet by 3 feet), can be completely textured with an amount of texture material equivalent to a supply of two cases of 12 spray cans.

Another advantage of using the texture sprayer 100 of the present invention is less texture material is wasted because there is less spillage of texture material from the hopper 120. For example, the texture sprayer 100 can be used at greater angles than the prior art apparatus without spillage. In general, the percent (%) loss or waste of texture material, from situations such as spills, malfunctions, and/or re-applications of layers of coatings to cover up mistakes, is less than about 5% loss, preferably less than about 3% loss, and more preferably less than about 2% loss as compared to prior art devices which can have as much as a 10% or more loss of texture material.

Still another advantage of using the texture sprayer 100 of the present invention comes when it is time to clean the texture sprayer after a job is finished. For example, the structural shape of the hopper assembly 110, aids in thoroughly cleaning the hopper assembly 110. Because the upper elongated tubular section 121a and the annular section 121c of the hopper 120 are tubular in shape; and the a conical section 121b near the discharge opening 121e of the hopper 120 is tapered; there are no angles of repose, such as ledges, for texture material to settle on, or get hung up on and plug the discharge opening 121e at the annular ring hopper section 121c; and therefore, the hopper 120 can be easily, quickly and thoroughly cleaned.

In addition, another advantage of the present invention is once the hopper 120 has been fully used and the work job is done, the hopper 120 can be removed from the spray gun 20 and the bottom drain orifice, i.e., the discharge opening 121e can be sealed to prevent any texture material from continuing to discharge from the hopper 120. The discharge opening 121e can be sealed using the removable cover 150 such as bottom lid 151. Using the re-closable lid 141 for the top feed opening 121d and the re-closable bottom cover 151 for the bottom discharge opening 121e, both ends of the hopper 120 can be closed air tight. Thus, when the hopper 120 is not in use or needs to be stored, any texture material remaining in the hopper 120 may be preserved, i.e., protected from drying out, for future use at a future job site by enclosing the texture material using both covers 140 and 150. Thus, one advantage of sealing the hopper is allowing the user to clean the hopper less frequently.

The texture sprayer 100 of the present invention present invention may be used to provide coatings of texture materials for surfaces of various architectural structures, for example, interior and exterior walls of buildings. For example, the present invention texture sprayer is useful for coating surfaces such as ceilings, floors or walls of the interior of a commercial building or a non-commercial housing unit including homes and apartments. In general, the present invention may be used to spray texture material to any surface amenable to be spray coated with a texture material. For example, as an illustration of the present invention, the interior walls of houses may be sprayed with texture material for aesthetic purposes or for functional purposes. In one embodiment, the texture sprayer 100 of the present invention can also be utilized for drywall finishing to achieve an aesthetic effect or acoustical effect. In another embodiment for example, a protective coating can be sprayed on a wall to protect the wall or an acoustical coating may be sprayed on the wall to improve the acoustics of the wall.

The hand-held, pressure-operated, texture sprayer 100 of the present invention of the present invention may also be designed to apply textured materials to perform touchup and repair work on texturized walls and ceilings of rooms, of for example, a residence, an office building and the like. The handheld, pressurized texture sprayer 100 of the present invention may also be used for patching acoustic ceilings and repairing cracks and damage in and on existing texturized walls and ceilings, for example, by applying a texture sealing compound thereto.

When texture material is sprayed onto a surface using the texture sprayer 100 of the present invention, various texture results can be obtained including for example, textured coatings commonly referred to as “pop corn” texture, “cork” texture, “sand” texture, “orange peel” texture, an acoustic texture; and other textures well known in the art; and with various thicknesses of the resultant texture coating.

Another advantage of using the texture sprayer 100 of the present invention includes obtaining a better quality finished work product. For example, in terms of the thickness of the coating applied to a surface, the surface thickness is substantially uniform throughout the thickness of the coating (thus, less texture material is required which, in turn, provides less waste of texture material). The application thickness of the texture material to form the texture coating may be identified as a “light”, “medium” or “heavy” texture coating. For example, the light texture coating can be up to about 1/16 inch in thickness; the medium texture coating can be up to about ⅛ inch in thickness; and heavy texture coating can be up to about ¼ inch or more in thickness.

Another advantage of using the texture sprayer 100 of the present invention includes obtaining a uniform texture coating across the entire work surface area. Thus, substantially the entire surface can be coated uniformly with the texture sprayer 100 of the present invention. For example, the coverage of the surface area is generally from about 95% to about 100% in one embodiment; and from about 98% to about 100% in another embodiment. However, any desired amount of texture material can be applied to a surface and any desired amount of surface area can be covered or intentionally left uncovered with texture material as desired. In addition, hard to reach places such as surfaces behind furnaces and surfaces inside closet spaces can be coated with a substantially uniform thickness of the coating without sacrificing quality or the quantity of texture material coating.

### EXAMPLES

The following examples further illustrate the present invention in detail but are not to be construed as limiting the scope thereof.

### Comparative Example A

A prior art texture spraying apparatus, shown in FIG. 1, having roughly the following dimensions: 11 inches in length by 11 inches in width by 15 inches in height, was used to spray a texture material onto the surfaces of a standard size closet in an apartment complex. It took one operator about 2 hours to complete the job and several more hours to clean the surfaces that were not meant to be coated. More time was spent cleaning up wasted texture material sprayed on unintended surfaces than was spent spraying texture material on the intended walls of the closet.

### Example 1

A texture sprayer 100 of the present invention, shown in FIGS. 2, 10 and 11, was used in this Example 1. The hopper assembly 110 in this embodiment comprised a one-piece hopper 120 made up of three hopper sections 121a, 121b and 121c integral with each other, including an upper elongated tubular hopper section 121a integral with a conical middle hopper section 121b, which in turn, is integral with a lower annular ring hopper section 121c; i.e., the upper elongated tubular hopper section 121a was integrally connected to the lower annular ring hopper section 121c having a two-inch diameter, via the funnel-shaped tapered middle transition hopper section 121b. The upper elongated tubular section 121a had a length of 12 inches and a diameter of 4 inches such that the L/D ratio of the upper elongated tubular section 121a was 3.

The two-inch diameter lower annular ring hopper section 121c was connected to the base 21 of a spray gun 20 via a clamping means 130. The texture sprayer 100 of the present invention used in this Example 1 was used to spray a texture material on to the wall surfaces of a closet, the same size as described in Comparative Example A above. It took only about 10 minutes to complete the same job with less texture material, less waste of texture material, and more complete coverage of the surface with a “medium” texture material, particularly in hard to reach areas such as between the shelf of a closet and the ceiling of the closet.

The process and apparatus of the present invention are not to be limited by the specific example set forth above. Rather, the above example is only illustrative of the present invention.

What is claimed is:

1. A hopper assembly adapted for being removably connected to a spraying apparatus, said hopper assembly comprising:
(a) a hopper reservoir housing; wherein the hopper reservoir housing comprises an elongated tubular housing member having a length to diameter (L/D) ratio of from about 0.25 L/D ratio to about 36 L/D ratio; and wherein the elongated tubular housing member includes a feed orifice at a distal end of the elongated tubular housing member and a discharge orifice at a proximal end of the elongated tubular housing member; said proximal end of the elongated tubular housing member adapted to being removably attached to a spraying apparatus;
(b) a means for removably attaching said hopper reservoir housing to the spraying apparatus; and
(c) optionally, a re-closable cover means adapted to being removably attached to the feed opening at the distal end of the elongated tubular housing member.

2. The hopper assembly of claim 1, wherein the hopper reservoir housing comprises:
(i) an upper elongated tubular housing section having a feed opening and a discharge opening;
(ii) a lower elongated tubular housing section having a feed opening and a discharge opening; and
(iii) a conical housing middle section having a feed opening and a discharge opening; wherein the conical housing middle section is integrally disposed in between the upper elongated tubular housing section and lower elongated tubular housing section therewith; wherein the diameter of the feed opening of the conical housing middle section is integral with, and has the same diameter as, the discharge opening of the upper elongated tubular housing section; wherein the diameter of the discharge opening of the conical housing middle section is integral with, and has the same diameter as, the feed opening of the lower elongated tubular housing section; and wherein the upper elongated tubular housing section has a length to diameter (L/D) ratio of from about 0.25 L/D ratio to about 36 L/D ratio.

3. The hopper assembly of claim 2, wherein the feed opening of the upper elongated tubular housing section is adapted for feeding a texture material into the hopper reservoir housing; and wherein the discharge opening of the lower elongated tubular housing section is adapted to being removably connected to, and is in fluid communication with, the spraying apparatus such that the texture material contained in the hopper reservoir housing will flow into the spray gun.

4. The hopper assembly of claim 2, including a sealable cover means adapted for being removably attached to the feed opening of the upper elongated tubular housing section.

5. The hopper assembly of claim 2, including an indicator means attached to the hopper reservoir housing adapted for determining the level of texture material contained in the hopper reservoir housing.

6. The hopper assembly of claim 5, wherein the indicator means comprises a portal of translucent material in at least a portion of the wall of the hopper reservoir housing such that when the hopper is not comprised of a translucent material, the texture material level is permitted to be known.

7. The hopper assembly of claim 2, including a sealable cover means adapted for being removably attached to the discharge opening of the lower elongated tubular housing section.

8. The hopper assembly of claim 2, wherein the hopper reservoir housing includes a handle adapted for lifting or holding the hopper assembly.

9. A hopper-type texture spray gun applicator apparatus comprising (a) the hopper assembly of claim 1; and (b) a spray gun; wherein the hopper assembly is removably mounted on the spray gun and is engaged in fluid communication with the spray gun; and wherein the hopper assembly is adapted to contain texture material to be sprayed and to direct the texture material in a funnel-like fashion to the spray gun.

10. The apparatus of claim 9, wherein the spray gun includes a nozzle orifice adapted for discharging a spray stream from the spray gun.

11. The apparatus of claim 10, including (c) a pressure source adapted for being removably attached to the spray gun; wherein the pressure source passes a fluid under pressure through the spray gun and toward the nozzle orifice of the spray gun to entrain texture material being fed from the hopper to the spray gun; wherein the fluid is air; and wherein the spray gun is adapted for discharging a spray pattern of texture material entrained in the air from the nozzle orifice of the spray gun.

12. The apparatus of claim 11, wherein the pressure source is an air compressor.

13. The apparatus of claim 9, further comprising a sealable cover for the feed opening at the top distal end of the elongated tubular section of the hopper.

14. The apparatus of claim 9, wherein the hopper assembly is adapted for being tilted or rotated, about an axis in a vertical or horizontal direction, at angles of from about 10 degrees to about 170 degrees during operation of the hopper-type texture spray gun applicator.

15. A process of spraying a texture material onto a surface area to form a coating on said surface area comprising spraying a texture material onto the surface area to form a coating thereon using the hopper-type texture spray gun applicator of claim 9.

16. The process of claim 15, wherein the surface area is a wall, floor or ceiling.

17. The process of claim 15, wherein the surface area is a closet wall.

18. The process of claim 15, wherein the surface area is a wall behind an obstruction.

19. The process of claim 15, wherein the obstruction is a water heater or furnace.

20. The process of claim 15, wherein the surface area is in the interior of a building.
